(19) United States
(12) Patent Application Publication
(10) Pub. No.: US 2005/0176417 A1
(43) Pub. Date: Aug. 11, 2005

(54) Telecommunication system

(76) Inventors: Ray G. Files, Carlsbad, CA (US); Darry L. Boyd, San Diego, CA (US)

Correspondence Address: STETINA BRUNDA GARRED & BRUCKER, 75 ENTERPRISE, SUITE 250, ALISO VIEJO, CA, 92656, US

(21) Appl. No.: 10/936,895

(22) Filed: Sep. 9, 2004

Related U.S. Application Data
(63) Continuation-in-part of application No. 10/775,776, filed on Feb. 9, 2004.

(51) Int. Cl. H04Q 7/20

(52) U.S. Cl. 455/422.1

(57) ABSTRACT

A system and related methods are provided for facilitating communication between one or more landline phones and other communication devices. In various embodiments, incoming communications such as telephone calls and/or other transmissions received from one or more mobile phones, computing devices, and/or other communication devices can be routed through a base unit to one or more landline phones for convenient operation by a user. Such communications can be routed through a base unit to an interface unit for distribution to additional landline telephones. Incoming landline telephone calls can also be routed to one or more landline phones and/or one or more mobile phones, computing devices, and/or other communication devices. Communications received from mobile phones and other devices can be appropriately blocked from inadvertent transmission over the telecommunication system of a landline service provider.

### CROSS-REFERENCE TO RELATED APPLICATIONS

This application is a continuation-in-part of, and claims the benefit of, U.S. patent application Ser. No. 10/775,776, filed on Feb. 9, 2004, which is incorporated by reference herein.

### STATEMENT RE: FEDERALLY SPONSORED RESEARCH/DEVELOPMENT

Not Applicable

### BACKGROUND OF THE INVENTION

With the rise of wireless communications in recent years, consumers are increasingly relying on the use of mobile telephones and other devices in the course of their daily communications. Businesspersons also rely on such technologies for conducting transactions and other business in the marketplace. Indeed, both consumers and businesspersons often utilize one or more wireless devices as a way of life.

Unfortunately, much of the existing communication infrastructure in homes and in businesses is exclusively land-based. This creates a problem for persons who seek to use their wireless devices in conjunction with other land-based technology. For example, although a consumer may prefer the wireless freedom provided by a mobile telephone, the consumer's home will likely be equipped with only fixed landline telephone jacks to be used with traditional landline telephones. Such circumstances can require consumers to maintain two separate telephone accounts: one account for the mobile phone and a second account for landline telephone communications. In addition, such separate accounts will typically be associated with different telephone numbers, thereby further complicating the ability of consumers to engage in convenient communication.

In view of these problems, there exists a need for a streamlined approach to the integration of wireless and landline communications. Such an approach would preferably provide functionality that facilitates the use of landline telephones with wireless technologies and/or wireless telephones.

### BRIEF SUMMARY OF THE INVENTION

The present invention, roughly described, provides an improved telecommunication system and related methods for facilitating communication between one or more landline phones and other communication devices. In various embodiments, incoming communications such as telephone calls and/or other transmissions received from one or more mobile phones, computing devices, and/or other communication devices can be routed through a base unit to one or more landline phones for convenient operation by a user. Such communications can be routed through a base unit to an interface unit for distribution to additional landline telephones. Incoming landline telephone calls can also be routed to one or more landline phones and/or one or more mobile phones, computing devices, and/or other communication devices.

In one embodiment, a method is provided for facilitating communication between a landline phone and a communication device. An incoming communication signal from the communication device can be detected, and the communication signal can be converted from a signal format associated with the communication device to a signal format compatible with the landline phone. The converted signal can be transmitted to the landline phone for receipt by a user of the landline phone. Additional steps can be provided for detecting whether a landline of a landline telecommunication system is in use and, if the landline is not in use, isolating the landline phone from the landline telecommunication system.

These as well as other embodiments contemplated by the present invention will be more fully set forth in the detailed description below and the figures submitted herewith.

### BRIEF DESCRIPTION OF THE DRAWINGS

FIG. 1 illustrates a block diagram of a telecommunication system in accordance with an embodiment of the present invention.

FIG. 2 illustrates a block diagram of an interface unit of a telecommunication system in accordance with an embodiment of the present invention.

FIG. 3 illustrates a block diagram of a base unit of a telecommunication system in accordance with an embodiment of the present invention.

FIG. 4 illustrates a process performed in response to an incoming mobile telephone call, in accordance with an embodiment of the present invention.

FIG. 5 illustrates an alternate process performed in response to an incoming mobile telephone call, in accordance with an embodiment of the present invention.

FIG. 6 illustrates a process performed in response to an incoming landline telephone call, in accordance with an embodiment of the present invention.

### DETAILED DESCRIPTION OF THE INVENTION

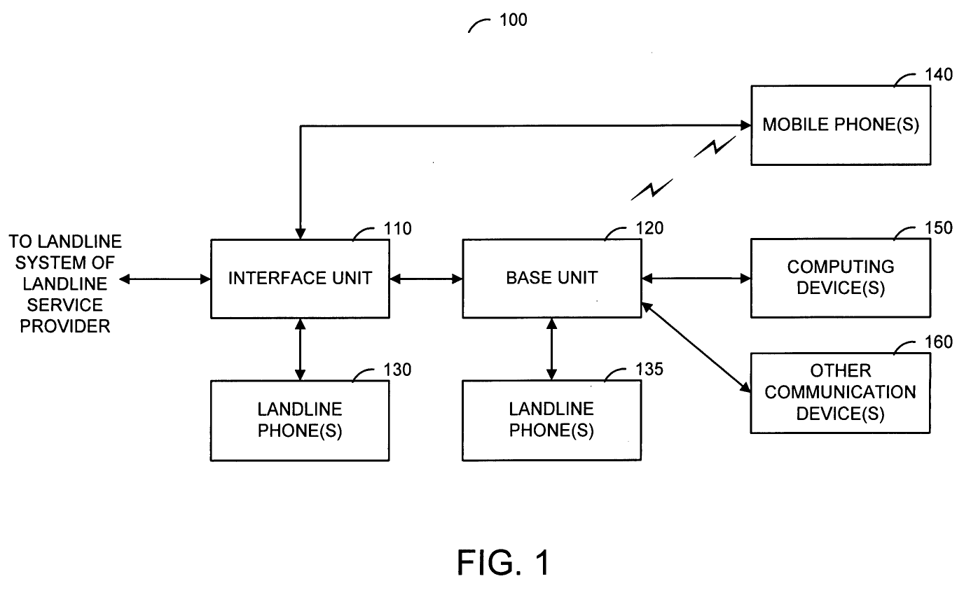

FIG. 1 illustrates a block diagram of a telecommunication system 100 in accordance with an embodiment of the present invention. Through the operation of system 100, incoming communications (such as telephone calls and/or other transmissions) received from one or more mobile phones 140, computing devices 150, and/or other communication devices 160 can be routed through a base unit 120 to one or more landline phones 135 for convenient operation by a user. In addition, such communications can be routed through a base unit 120 to an interface unit 110 for distribution to additional landline telephones 130. Incoming landline telephone calls can also be routed to one or more landline phones 130 and 135 and/or one or more mobile phones 140, computing devices 150, and/or other communication devices 160. It will be appreciated that many alternate embodiments of the system 100 can be provided in accordance with the present invention, as further described herein. For example, if a user desires to conduct mobile telephone conversations using a landline phone 130 but does not desire to use any services of a landline service provider, a simplified system may be implemented without interface unit 110. In another embodiment, if a user does not desire to use the functionality of the base unit 120, a system in accordance with the present invention may alternatively be implemented without base unit 120.

As illustrated in FIG. 1, an interface unit 110 is in communication with a landline telecommunication system of a conventional landline telephone service provider. For example, interface unit 110 can be interfaced with a junction box of a building or other structure that is serviced by a landline telephone service provider. Interface unit 110 can also interface with physical landline telephone wires that may exist in a particular building or structure in which the system 100 is implemented in order to connect with landline phones 130 therein. Interface unit 110 can further be implemented to provide appropriate connections for directly interfacing with landline phones 130, mobile phones 140, computing devices 150 (connection not shown), and/or other communication devices 160 (connection not shown).

Interface unit 110 can be implemented to direct incoming landline telephone calls received from the landline service provider's system from being transmitted to mobile phones 140, computing devices 150, and/or other communication devices 160 in communication with the system 100. In addition, interface unit 110 can be implemented to direct incoming telephone calls received from mobile phones 140, computing devices 150, and/or other communication devices 160 in communication with the system 100 from being transmitted to the landline service provider's system.

Base unit 120 can facilitate communication between mobile phone 140, computing device 150, and/or other communication devices 160, and landline phones 135 and interface unit 110 through physical connections and/or wireless connections. It will be appreciated that although mobile phone 140 is illustrated as communicating wirelessly with base unit 120 in FIG. 1, physical connections between base unit 120 and mobile phone 140 are also contemplated. It will further be appreciated that although other components of the system 100 are illustrated as communicating through physical connections, wireless connections are also contemplated.

It will be appreciated that mobile phone 140 can be any device compatible with wireless communication technology including but not limited to: any cellular technology, FDMA, TDMA, CDMA, and/or other technologies. It will also be appreciated that computing device 150 can be any computing device capable of providing communication functionality. For example, in one embodiment, computing device 150 can be a personal computer capable of providing voice-over-IP communication over a network (not shown), such as the Internet. Other communication devices 160 are also contemplated including, but not limited to: cameras, facsimile devices, security systems, modems, copiers, and others.

Base unit 120 can be implemented to provide appropriate connections for directly interfacing with landline phones 135. Base unit 120 can be further implemented to transmit and receive the voice content of telephone calls to and from interface unit 110. In various embodiments, such communication can be performed using physical connection(s) between the base unit 120 and interface unit 110, and/or wireless technologies. In one embodiment using wireless technology, the voice content of telephone calls can be communicated between base unit 120 and interface unit 110 using the 2.4/5.8 GHz frequency band. Such communication can employ a dual band technology to permit simultaneous transmission and reception between the base unit 120 and interface unit 110. Such communication can also employ digital spread spectrum technology. By keeping both the transmitter and receiver synchronized with accurate clocks and a pseudo-random number generator, the ability of other persons to eavesdrop or jam such communications can be minimized. Because of the digital nature of such communications, and the constantly changing frequency channels in use, only the base unit 120 and interface unit 110 will have copies of the pre-assigned spreading codes utilized by the spread spectrum communication. It will be appreciated that millions of such codes are available and can be selected automatically in response to an incoming telephone call. The base unit 120 and interface unit 110 can also be implemented to operate using a transmission power of 1 watt (transmission power) or less.

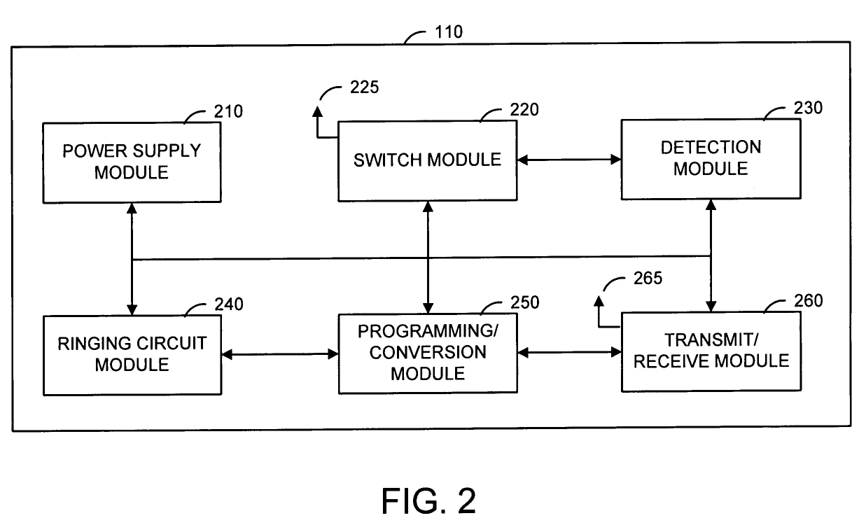

FIG. 2 illustrates a block diagram of an interface unit 110 of a telecommunication system 100 in accordance with an embodiment of the present invention. As illustrated, interface unit 110 can be implemented to comprise a power supply 210, switch module 220, antenna 225, detection module 230, ringing circuit module 240, programming/conversion module 250, transmit/receive module 260, and antenna 265. The various components of interface unit 110 can be controlled in accordance with any appropriate control system technologies known in the art (not shown).

Power supply 210 provides electrical power to the various components of the interface unit 110. Switch module 220 provides a switch that, can selectively connect and disconnect the system 100 from a landline provided by a landline service provider, thereby permitting switch module 220 to direct telephone calls as described above. In various embodiments, the switch can be an electronic switch configured to interface between the landline service provider's system and the landline telephone wires of the building or structure in which the system 100 is implemented, thereby allowing the system 100 to be selectively isolated from the landline service provider's system. In certain embodiments, the switch can be activated in response to a signal received over antenna 225 and/or other components of the system. In one embodiment, the switch is implemented as a normally closed double pole double throw switch with a switching speed of less than 1 millisecond. Two feedback circuits can be employed to verify that the switch has in fact been switched. The switch can be implemented to switch to an impedance match circuit (approximately 1 KOhm) to simulate a landline telephone. Such a configuration permits incoming landline telephone calls to be received and processed by the system 100, and can also provide a closed circuit to permit proper interfacing and testing by the landline service provider.

Detection module 230 provides functionality for determining whether the landline received from the landline service provider is in use. Ringing circuit module 240 can provide a conventional telephone ring signal to landline telephone wires interfaced with interface unit 110 when an incoming telephone call is received from any of devices 140, 150, and/or 160. Different ring tones can be supported to distinguish between telephone calls originating from different mobile phone 140 lines and/or different communication devices 140, 150, and/or 160.

Programming/conversion module 250 provides programming functionality for the interface unit 110 and conversion functionality for performing bi-directional conversion of telephone calls between a landline-compatible format and one or more formats of communication devices 140, 150, and/or 160. Transmit/receive module 260 transmits and receives communications to and from mobile phone 140 through antenna 265.

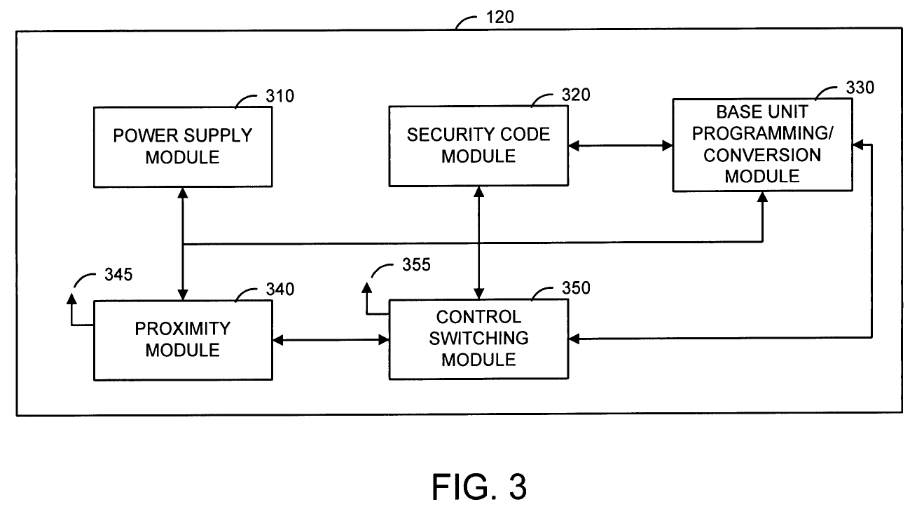

FIG. 3 illustrates a block diagram of a base unit 120 of a telecommunication system 100 in accordance with an embodiment of the present invention. As illustrated, base unit 120 can be implemented to comprise a power supply 310, security code module 320, base unit programming/conversion module 330, proximity module 340, antenna 345, control switching module 350, and antenna 355. The various components of base unit 120 can be controlled in accordance with any appropriate control system technologies known in the art (not shown).

Power supply 310 provides electrical power to the various components of the base unit 120.

Security code module 320 and base unit programming/conversion module 330 facilitate the programming of the base unit 120, as further described herein. Base unit programming/conversion module 330 can be implemented as a microprocessor and can also provide conversion functionality for performing bidirectional conversion of telephone calls between a landline-compatible format of landline phones 135 and one or more formats of communication devices 140, 150, and/or 160.

Proximity module 340 can detect the presence of a wireless device and/or incoming communications from a wireless device utilizing appropriate technology, such as a Bluetooth™ technology, in proximity to the base unit through antenna 340. Control switching module 350 operates to communicate the presence of such a wireless device to interface unit 110 through antenna 355, as further described herein.

In addition to the embodiments of interface unit 110 illustrated in FIG. 2 and base unit 120 illustrated in FIG. 3, it will be appreciated that many alternate embodiments are also contemplated.

In a first alternate embodiment of the interface unit 110, the interface unit 110 can be provided with appropriate hardware to be connected to an RJ11 and/or RJ13 jack located at a junction box of a landline telephone service provider at a house or small office. Such an embodiment can be implemented to have a size of approximately 1 inch square with standard telephone phone jack plug on each side. Once such an embodiment is plugged in, the interface unit 110 will automatically switch any telephone signal received from a landline of the landline telephone service provider once a signal is received from mobile phone 140 (received either wirelessly or from a base unit 120 located within the house or office). It will be appreciated that such an embodiment can be configured to provide such functionality for plural landlines of the landline telephone service provider. Such an embodiment can be used in conjunction with any of the first or second alternate embodiments of the base unit 120 further described herein.

In a second alternate embodiment of the interface unit 110, the interface unit 110 can be provided with appropriate hardware to be connected to commercial telephone jack connectors for large office hookup. Such an embodiment can be implemented to have a size of approximately 1 inch square, and can be connected into the back of each landline telephone in a large office for individual mobile phone users to prevent the mobile phones 140 of such users from feeding communications into the office telephone system. Such an embodiment can further provide an integrated base unit 120 (such as, for example, the first or second alternate embodiments of the base unit 120 further described herein) in order that only a single connection will be needed to set up the interface unit 110/base unit 120 at each desk or phone station of a large office. Such an embodiment can also provide a power source converter and/or can be powered from the landline telephone through appropriate hardware. Such an embodiment can further be implemented to charge the mobile phone 140 while the mobile phone 140 is connected to the interface unit 110/base unit 120. Additional connections can be provided on such an embodiment to facilitate the connection of headsets for hands-free communications.

In a third alternate embodiment of the interface unit 110, the interface unit 110 can be implemented in accordance with the first alternate embodiment of the interface unit 110 described above, with the interface unit 110 additionally configured to receive signals from a computer for use with the third alternate embodiment of the base unit 120, further described herein.

In a fourth alternate embodiment of the interface unit 110, the interface unit 110 can be provided with appropriate hardware to be connected to the back of any landline phone or similar equipment. Such an embodiment can be implemented to have a size of approximately 1 inch square, and can utilized in installations where access to outside RJ11 and/or RJ13 jacks is difficult or costly, such as in apartments, condominiums, and/or offices. Such an embodiment can permit individual landline phones to be used in conjunction with the first or second alternate embodiment of the base unit 120, further described herein.

In a fifth alternate embodiment of the interface unit 110, the interface unit 110 can be implemented as a combination switch integrated with one or more of the alternate interface unit 110 embodiments previously described herein.

In a first alternate embodiment of the base unit 120, base unit 120 can be located inside a house or small office with appropriate hardware for physically connecting to a mobile phone 140 and charging the mobile phone 140 while connected. Once the mobile phone 140 is connected, such an embodiment of the base unit 120 can send a signal to any of the various embodiments of interface unit 110 to prevent transmission of telephone calls between a landline of the landline telephone service provider and the mobile phone 140. In such an embodiment, the base unit 120 can facilitate the conversion of mobile phone 140 signals, whether digital, analog or otherwise, to standard landline telephone signals for distribution throughout the landline telephone wires of the house or small office. Such an embodiment would preferably not interfere with the normal operation of facsimile machines, modems, and/or other devices conventionally connected to such landline telephone wires. Such an embodiment would preferably be approximately the size of a small message machine or hands-free unit. Such an embodiment would also preferably include appropriate hardware for providing a hands-free and/or wired phone, power source, and/or appropriate adaptors for facilitating the physical connection of a plurality of different mobile phones 140.

In a second alternate embodiment of the base unit 120, base unit 120 can be small in size and located at an RJ11 and/or RJ13 jack in the same fashion as the first alternate embodiment of the interface unit 110 described above, or at any telephone jack of an appropriate building or structure. Such an embodiment can be implemented to provide proximity detection within a range of approximately 50 to 100 feet. Upon detection of the mobile phone 140 in proximity, a base unit 120 in accordance with such an embodiment can cause the system 100 to receive mobile telephone calls over landline phones 130 and/or 135.

In a third alternate embodiment of the base unit 120, base unit 120 can be external to, and/or embedded inside of, a computing device 150 to facilitate the communication between the computing device 150 and landline phones 130 and/or 135. In such an embodiment, the computing device 150 can interface with a conventional telephone jack and communicate to one or more landline phones in communication with the telephone jack (for example, through the standard telephone wiring of a building or other structure). Such an embodiment can be implemented to additionally provide the functionality of the first alternate embodiment of the base unit 120 described above. The third alternate embodiment of the base unit 120 can further be implemented to operate in conjunction with the first alternate embodiment of the interface unit 110 described above.

In a fourth alternate embodiment of the base unit 120, base unit 120 can be implemented in the same fashion as the third alternate embodiment of the base unit 120 with additional plug-and-play functionality for interfacing with a computing device 150 through USB, firewire, and/or other communication technologies.

In various embodiments, interface unit 110 and/or base unit 120 can be programmed to be associated with each other and/or mobile phone 140. In an embodiment of the system 100 employing both an interface unit 110 and a base unit 120, the mobile phone 140 can be physically connected to the base unit 120, and the base unit 120 can be physically connected to the interface unit 110. The base unit 120 can be programmed with an ID number associated with the mobile phone 140 through the interaction of a processor of base unit programming/conversion module 330 with the mobile phone 140. The interface unit 110 can be programmed with the mobile phone ID number through the interaction of a processor of programming/conversion module 250 with a processor of base unit programming/conversion module 330. In such an embodiment, the interface unit 110 can be associated with the base unit 120 through an interface unit ID number read by a processor of base unit programming/conversion module 330 from a processor of programming/conversion module 250 during programming. In such an embodiment, a user-selectable password can also be entered into base unit 120 through an appropriate user interface, including but not limited to a user-operable keypad. The password can be processed by a processor of base unit programming/conversion module 330 and sent to a processor of programming/conversion module 250 during programming. It will be appreciated that, through appropriate implementation of password security functionality in interface unit 110 and/or base unit 120, a user of such an embodiment can prevent other users from using the various functionality provided by such an embodiment.

In an embodiment of the system 100 that does not employ a base unit 120, the mobile phone 140 can be physically connected to the interface unit 110. The interface unit 110 can be programmed with an ID number associated with the mobile phone 140 through the interaction of a processor of programming/conversion module 250 with the mobile phone 140. In such an embodiment, a user-selectable password can also be entered into interface unit 110 through an appropriate user interface, including but not limited to a user-operable keypad. The password can be processed by a processor of programming/conversion module 250 during programming. It will be appreciated that, through appropriate implementation of password security functionality in interface unit 110, a user of such an embodiment can prevent other users from using the various functionality provided by such an embodiment.

In an embodiment of the system 100 that does not employ an interface unit 110, the mobile phone 140 can be physically connected to the base unit 120. The base unit 120 can be programmed with an ID number associated with the mobile phone 140 through the interaction of a processor of base unit programming/conversion module 330 with the mobile phone 140. In such an embodiment, a user-selectable password can also be entered into base unit 120 through an appropriate user interface, including but not limited to a user-operable keypad. The password can be processed by a processor of base unit programming/conversion module 330 during programming. It will be appreciated that, through appropriate implementation of password security functionality in base unit 120, a user of such an embodiment can prevent other users from using the various functionality provided by such an embodiment.

It will be appreciated that although various physical connections have been described in relation to the programming of interface unit 110 and base unit 120, wireless communications are also contemplated and can be substituted in place of one or more of such physical connections, where appropriate. It will further be appreciated that any of the various passwords and/or ID numbers described herein can be stored by interface unit 110 and/or base unit 120 in various formats, including but not limited to encrypted formats. It will additionally be appreciated that interface unit 110 and/or base unit 120 can be implemented such that after each has been programmed, the units will be associated with each other and/or a particular mobile phone 140. As a result, the units can be programmed to not operate with other interface units, base units, and/or mobile phones which may be nearby.

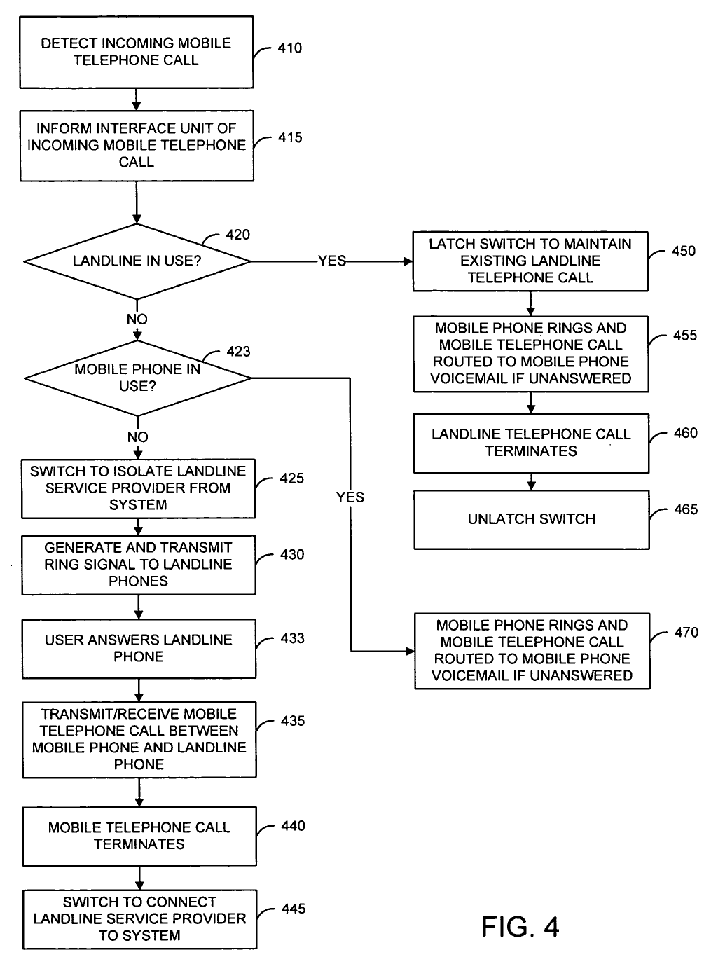

FIG. 4 illustrates a process performed in response to an incoming mobile telephone call, in accordance with an embodiment of the present invention.

At step 410, an incoming mobile telephone call is detected by the base unit 120. In various embodiments, this can be accomplished by the proximity module 340 of the base unit 120 detecting the presence of a mobile phone 140 and the incoming mobile telephone call through antenna 345. In one embodiment, a proximity range of approximately 40 feet can be supported. However, it will be appreciated that any desired proximity range can be implemented in accordance with the present invention. The proximity module 340 can then inform control switching module 350 of the existence of the detected incoming mobile telephone call. It will be appreciated that in other embodiments, the mobile phone 140 can be physically connected to base unit 120 (not shown), thereby allowing the base unit 120 to detect incoming mobile telephone calls directly from the physical connection of the mobile phone 140. In various embodiments, base unit 120 can provide appropriate hardware for charging the batteries of the mobile phone 140 while it is physically connected thereto, such as a port, receptacle, and/or other type of physical connection.

At step 415, control switching module 350 informs the interface unit 110 of the incoming mobile telephone call by transmitting a low-level (<1 watt) RF signal (2.4/5.8 GHz) to interface unit 110. The low-level signal can be received by antenna 265 of transmit/receive module 260 of interface unit 110, and communicated to detection module 230. At step 420, the detection module 230 interrogates the landline (provided by the landline telephone service provider) to which the interface unit 110 is connected. If detection module 230 detects that the landline is not currently in use, then the process of FIG. 4 continues to step 423. Otherwise, the process proceeds to step 450.

At step 423, if the mobile phone 140 is currently in use, then the process proceeds to step 470 where the incoming mobile telephone call causes the mobile phone 140 to ring normally and can be routed to an appropriate voicemail system associated with the mobile phone 140 if the call is not answered at the mobile phone 140. Otherwise, the process proceeds to step 425.

At step 425, switch module 220 switches its switch to isolate the landline service provider from the system 100 (step 425). As a result, the incoming mobile telephone call will not be transmitted across the landline provided by the landline service provider.

Upon the completion of step 425, ringing circuit module 240 generates and transmits a ring signal to the various landline phones 130 in communication with interface unit 110 (step 430). At step 433, a user answers one of the landline phones 130. The user can then conduct the mobile telephone call using the landline phone 130. The telephone call can be transmitted and received between the mobile phone 140 and interface unit 110 by transmit/receive module 260 (step 435). In addition, conversion between the landline phone signal format and the mobile phone signal format can be performed by programming/conversion module 250.

After the telephone call terminates (step 440), the switch module switches its switch to reconnect the landline service provider with the system 100 (step 445).

If it is detected in step 420 that the landline is in use, then the switch of switch module 220 is latched closed to prevent premature interruption of the existing landline telephone call (step 450). The incoming mobile telephone call causes the mobile phone 140 to ring normally and can be routed to an appropriate voicemail system associated with the mobile phone 140 if the call is not answered at the mobile phone 140 (step 455). In one embodiment, such routing can be implemented to take place in less than 1 millisecond. After the landline telephone call terminates (step 460), the switch of switch module 220 is unlatched (step 465).

It will be appreciated that appropriate steps of FIG. 4 can also be applied to an embodiment of the system 100 that is implemented without base unit 120. In such an embodiment, appropriate steps of FIG. 4 previously described as being performed by base unit 120 can be performed by interface unit 110. It will be appreciated that in such an embodiment, steps 410 and 415 can be replaced with the steps further set forth in this paragraph. An incoming mobile telephone call can be detected by the interface unit 110 through the physical connection of the mobile phone 140. It is also contemplated that such detection can be accomplished through a proximity module of the interface unit 110 (not shown) detecting the presence of a mobile phone 140 and the incoming mobile telephone call through an antenna (not shown) of such a proximity module in the manner previously described herein with regard to the proximity module 340 and antenna 345 of base unit 120. The transmit/receive module 260 is informed of the incoming mobile telephone call, which is then communicated to detection module 230.

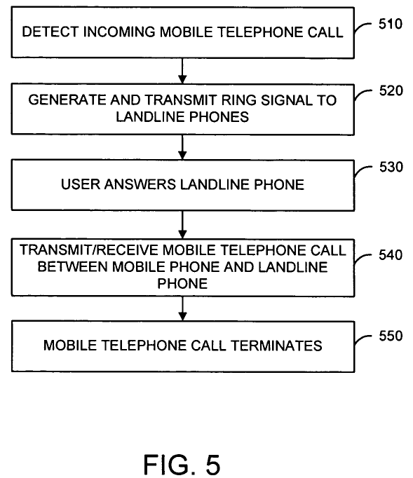

FIG. 5 illustrates an alternate process performed in response to an incoming mobile telephone call, in accordance with an embodiment of the present invention. The process of FIG. 5 can be performed by a simplified version of the system 100 that is implemented without interface unit 110.

At step 510, an incoming mobile telephone call is detected by the base unit 120. In various embodiments, this can be accomplished by the proximity module 340 of the base unit 120 as previously described in relation to FIG. 4.

At step 520, base unit 120 generates and transmits a ring signal to the various landline phones 135 in communication with the base unit 120 (step 430). It will be appreciated that such a ring signal could be implemented by appropriate hardware of the base unit 120. For example, base unit 120 could be provided with a ringing circuit module (not shown) in communication with proximity module 340 and/or other components of the base unit 120.

At step 530, a user answers one of the landline phones 135. The user can then conduct the mobile telephone call using the landline phone 135. The telephone call can be transmitted and received between the mobile phone 140 and base unit 120 through the antenna 355 of control switching module 350. In addition, conversion between the landline phone signal format and the mobile phone signal format can be performed by base unit programming/conversion module 330. Thereafter, the telephone call can terminate (step 550).

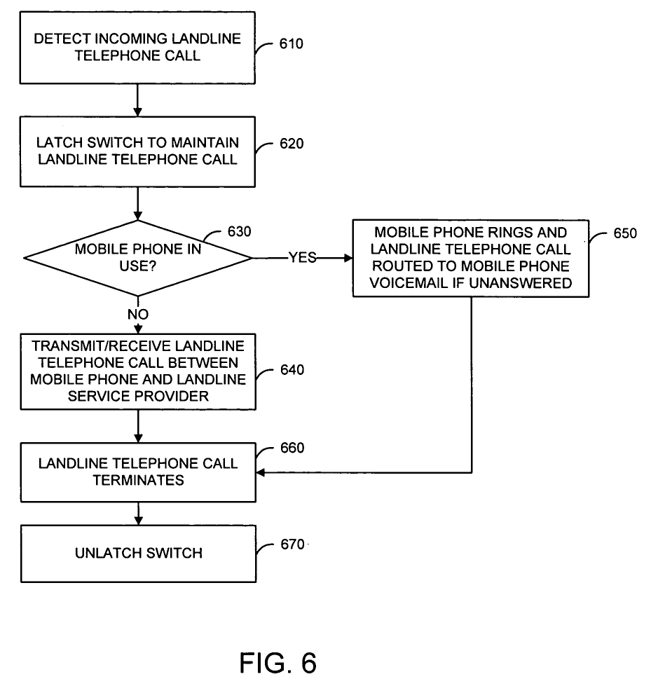

FIG. 6 illustrates a process performed in response to an incoming landline telephone call, in accordance with an embodiment of the present invention.

At step 610, detection module 230 of interface unit 110 detects an incoming landline telephone call. The switch of switch module 220 is then latched closed to prevent premature interruption of the incoming landline telephone call (step 620).

If the mobile phone 140 is not in use (step 630), then the landline telephone call can be transmitted and received between the mobile phone 140 and interface unit 110 by transmit/receive module 260 (step 640). Otherwise, if the mobile phone 140 is already in use, the incoming landline telephone call causes the mobile phone 140 to ring normally and can be routed to an appropriate voicemail system associated with the mobile phone 140 if the call is not answered at the mobile phone 140 (step 650). The base unit 120 can be implemented with appropriate hardware to provide an audible signal to inform the user that an incoming landline telephone call was received.

After the landline telephone call terminates (step 660), the switch of switch module 220 is unlatched (step 670).

Although the processes of FIGS. 4, 5, and 6 have been described in relation to mobile telephone calls, it will be appreciated that the disclosure of the present invention can also be applied to any other desired form of communication sent or received by the system 100 in relation to devices 140, 150, and/or 160.

It will be appreciated that the scope of the present invention is not limited by the particular embodiments set forth herein. Other appropriate variations, whether explicitly provided for or implied, are contemplated by the present disclosure. It is contemplated that any of interface unit 110, base unit 120, and/or other components of system 100 can be combined and/or separated into other configurations. For example, the interface unit 110 and base unit 120 can be combined into one or more units capable of providing some or all of the various functionality described herein. The ordering of various steps described herein can be changed where appropriate to achieve the functionality provided by the present invention. Similarly, individual steps can be combined and/or dissected into fewer or greater numbers of steps where appropriate to provide the functionality described herein.

1. A method for facilitating communication between a landline phone and a communication device, the method comprising:
detecting an incoming communication signal from the communication device;
converting the communication signal from a signal format associated with the communication device to a signal format compatible with the landline phone; and
transmitting the converted signal to the landline phone.

2. The method of claim 1, further comprising:
detecting whether a landline of a landline telecommunication system is in use; and
if the landline is not in use, isolating the landline phone from the landline telecommunication system.

3. The method of claim 2, the communication device is a computing device.

4. The method of claim 2, the communication device is a mobile phone, the incoming communication signal is a mobile phone telephone call.

5. The method of claim 4, further comprising:
detecting a proximity of the mobile phone.

6. The method of claim 4, the isolating step further comprising:
disconnecting the landline telephone from the landline telecommunication system.

7. The method of claim 6, the isolating step is performed by a switch.

8. The method of claim 6, further comprising:
transmitting a ring signal to the landline phone.

9. An interface unit for facilitating communication between a landline phone and a communication device, the interface unit comprising:
a switch module comprising a switch for selectively directing communication between a landline telecommunication system and the interface unit;
a detection module for detecting whether a landline of a landline telecommunication system is in use; and
a conversion module for converting between a landline phone signal format and a mobile phone signal format.

10. The interface unit of claim 9, further comprising:
a connection for interfacing with a landline phone.

11. The interface unit of claim 9, further comprising:
a base unit.

12. A base unit for facilitating communication between a landline phone and a communication device, the base unit comprising:
a proximity module for detecting the proximity of a mobile telephone; and
a conversion module for converting between a landline phone signal format and a mobile phone signal format.

13. The base unit of claim 12, further comprising:
a connection for interfacing with a landline phone.

14. The base unit of claim 12, further comprising:
a port for receiving the mobile phone and charging the mobile phone.

15. The base unit of claim 12, further comprising:
an interface unit.

16. A system for facilitating communication between a landline phone and a computing device, the system comprising:
a unit for receiving a communication signal from the computing device;
a conversion module for converting the communication signal from a format compatible with the computing device to a format compatible with a landline phone; and
a connection for interfacing with a landline phone.

17. The system of claim 16, the conversion module is embedded in the computing device.

18. The system of claim 16, the communication signal is a telephone call.

19. The system of claim 16, the communication signal is a voice-over-IP communication.
